(19) United States
(12) Patent Application Publication
(10) Pub. No.: US 2007/0063563 A1
(43) Pub. Date: Mar. 22, 2007

(54) Tiltable chair accommodating male and female user seating position preferences

(76) Inventors: Jackie Maze, Toronto (CA); Michael Keilhauer, North York (CA)

Correspondence Address: PATTERSON & SHERIDAN, L.L.P., 3040 POST OAK BOULEVARD, SUITE 1500, HOUSTON, TX, 77056, US

(21) Appl. No.: 11/355,618

(22) Filed: Feb. 16, 2006

(30) Foreign Application Priority Data
Sep. 21, 2005 (CA) 2,520,267

(51) Int. Cl. B60N 2/00

(52) U.S. Cl. 297/317

(57) ABSTRACT

The invention provides a tiltable chair accommodating male and female user seating position preferences. The chair has a movable seat pan, which can be actuated into forward and aft positions. At least one position is associated with a female position, and at least one position is associated with a male position. The chair may have a back support or may be backless.

### BACKGROUND OF THE INVENTION

1. Field of the Invention

The invention relates to chairs, and more specifically to tiltable chairs.

2. Description of the Related Art

An occupant of a chair, such as an office chair, does not remain stationary throughout the course of the day. The occupant is frequently required to change position, whether to move the occupant's spatial position on the floor, or to rotate to face sideward or rearward, or to reach for an object positioned away from the occupant.

To an extent, modern desk chairs address these mobility concerns by providing caster wheels on the base (allowing spatial positioning) and by providing a swivel means immediately below the seat part of the chair (allowing the occupant to face in different directions). However, chair designers have had difficulty addressing the reach concern without compromising the comfort or safety of the occupant.

The ability to move in place while seated is also an ergonomic issue. Certain recent seating improvements have allowed the occupant to tilt in various directions. This moderate degree of mobility is considered important to improve circulation and accommodate the natural “restlessness” of the body, even while seated. Even in stationary chairs, occupants tend to shift their body weight, by leaning from side-to-side and back-and-forth. Stress on the spine and ischia and reduced blood flow to the legs can result if such natural shifting movement is not accommodated in the chair.

While many chairs provide rearward tilting of the seat pan or seat back (or both) to allow the occupant to partially recline, tilting the entire chair at the base more closely mimics the natural shifting movements of the body, using the ankles as a pivot point. The base tilt also allows the occupant's feet to stabilize the chair. Such tilting should be accommodated as an additional feature in harmony with other normal functions of a chair, such as swiveling and spring-based “bouncing”. A useful design for a tilting and swiveling chair is provided in U.S. patent application Ser. No. 11/190,268 filed on Dec. 1, 2004, assigned to a common assignee with the present application, the disclosure of which is incorporated by reference.

### SUMMARY OF THE INVENTION

In testing the tilting and swiveling chair referred to above, the applicants made the surprising discovery that men and women do not sit the same way on office chairs, and this difference was particularly marked when men and women were observed using the tilting and swiveling chair.

Men and women exhibit differences in postural alignment and seating position. Women tend to sit with a more anteriorly rotated pelvis, less lumbar flexion, and very little trunk flexion. Men tend to sit with a posteriorly rotated pelvis, greater lumbar flexion, and more forward leaning trunk postures.

In addition, women tend to sit anterior to the pedestal base of a chair, with their upper body centre of mass closer to the seat pan centre of pressure than men. Men tend to sit with upper body centre of mass and hip joint located posterior to the pedestal base of a chair. Seat pan pressure profiles of men and women show that women tend to exhibit a more focal area of peak pressure versus men's more diffuse pressure. This peak pressure is located further behind the centre of pressure of male than in women. This is believed to be connected to the more slouched posture and posterior rotated pelvis observed in men.

Taken as a whole, it has been observed that men tend to slouch against a back rest, while women tend to perch closer to the front of the seat pan (away from the back rest).

The invention therefore provides a chair that is tiltable while also accommodating the observed male and female user seating position preferences. The chair comprises:

a base;

a seat frame;

a pedestal portion in between and connecting the base and the seat frame, the pedestal portion being tiltable proximate to the base, so as to tilt the seat frame;

a seat pan mounted on the seat frame and moveable thereon in forward and aft directions; and

an adjustor to actuate movement of the seat pan with respect to the seat frame to pre-selected positions in the forward and aft directions.

The positions preferably include a female position and a male position. That is, at least one of the positions is “associated with” a female position, while at least one of the positions is “associated with” a male position.

The female position and the male position may be marked on the chair as a useful guide to the user for adjusting the seat pan position. Positions may be marked on the seat frame, the seat pan, or on the actuator, or some combination of these. The positions may also be marked generically on the chair (or not marked at all), and interpretive information on male and female positions may be provided separately (such as in an accompanying brochure, website, or personal instruction). This is what is meant herein by positions being “associated with” male and female positions.

The seat pan can be actuated into at least two predetermined positions. The forward position of the seat pan with respect to the seat frame preferably corresponds to a male position, while the aft position corresponds to a female position.

The seat frame is preferably provided with a back portion having a back support, in which case, the back portion provides a frame of reference for the forward and aft directions of the seat pan. Alternatively, the seat frame may be backless, in which case, the forward and aft directions may be determined relative to the user. Preferably, the chair comprises an office chair.

The base of the chair may be stationary, or the base may have means for allowing the chair to roll.

Preferably, the pedestal portion comprises a spring assembly for up and down movement driving the seat frame and seat pan in series. Preferably, the chair comprises a tilt assembly for allowing the chair to slew proximate to the base. Preferably, the tilt assembly includes a tilt limiter to limit the degree of tilt in selected directions. A useful description of a mechanism to provide these features is provided in U.S. patent application Ser. No. 11/190,268, filed on Dec. 1, 2004, the disclosure of which is incorporated herein by reference. However, the chair described in that patent application does not disclose an adjustable seat pan as herein provided.

The seat pan preferably comprises a first side facing the user, and a second side facing the seat frame, wherein the seat pan comprises a plurality of slots defined in the second side, the slots being engageable by a locking mechanism on the actuator to at least temporarily retain the seat pan in a pre-selected position.

The actuator preferably comprises a lever pivotally attached to the seat frame, the lever having a proximate end manually accessible to the user, and an opposite distal end, the locking mechanism being attached to the distal end for engagement in at least one of the slots on the seat pan.

Preferably, the locking mechanism comprises at least one projecting tooth (preferably two projecting teeth) attached to the lever for engagement in at least one of the slots on the seat pan. The teeth, and in fact the entire locking mechanism, may be a unitary piece with the lever.

If a back support is provided, this may take any shape. It may be especially beneficial to provide an inverted T-shaped back support, which is relatively narrower between the user's shoulder blades and relatively wider proximate to the user's lower back. An exemplary shape of such back support is shown in U.S. Design Pat. No. 420,841, issued Feb. 22, 2000 to Ed Keilhauer, incorporated herein by reference. There is an unexpected advantage of using this style of back support for the present invention, in that the tilting action of the chair provides more freedom of movement for the user and the narrow upper portion of the back support does not interfere with the user's shoulder blades. This clearance allows the user to twist more freely in sideward orientations.

Either in combination with the inverted T-shape back support, or in combination with another shape of back support, it is preferable to provide an opening in the lower back support portion. The opening is adapted to allow the user's buttocks to protrude out when the user is positioned against the back support as the seat pan is moved in the aft direction. This is to allow the user to sit flush against the back support. The user's buttocks, thus, do not prevent the user's back from resting against the back support.

The foregoing are examples of certain aspects of the present invention. Many other embodiments are also possible and will become apparent to those skilled in the art from a review of the detailed description of certain preferred embodiments of the present invention.

### BRIEF DESCRIPTION OF THE FIGURES

FIG. 1 shows a perspective view of a preferred embodiment of the chair.

FIG. 1A shows a perspective view of the chair when tilted from the base.

FIGS. 2A and 2B show side elevation views of the chair showing the seat pan moved in forward and aft directions.

FIG. 3 shows an exploded view of a preferred seat pan and seat frame (excluding back portion).

FIG. 4 shows a detailed view of the lever and locking mechanism, showing possible exemplary male and female position marking.

FIG. 5 shows a first exemplary back support for the chair (inverted T).

FIG. 6 shows a second exemplary back support for the chair (with cutout).

FIGS. 7A and 7B show male and female sitting positions (with users, illustrating spinal and hip placement).

### DETAILED DESCRIPTION

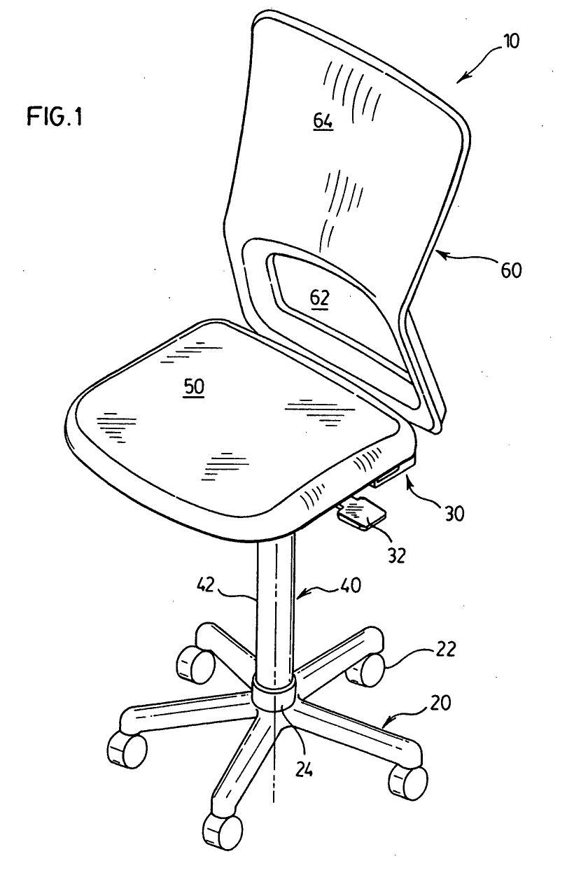

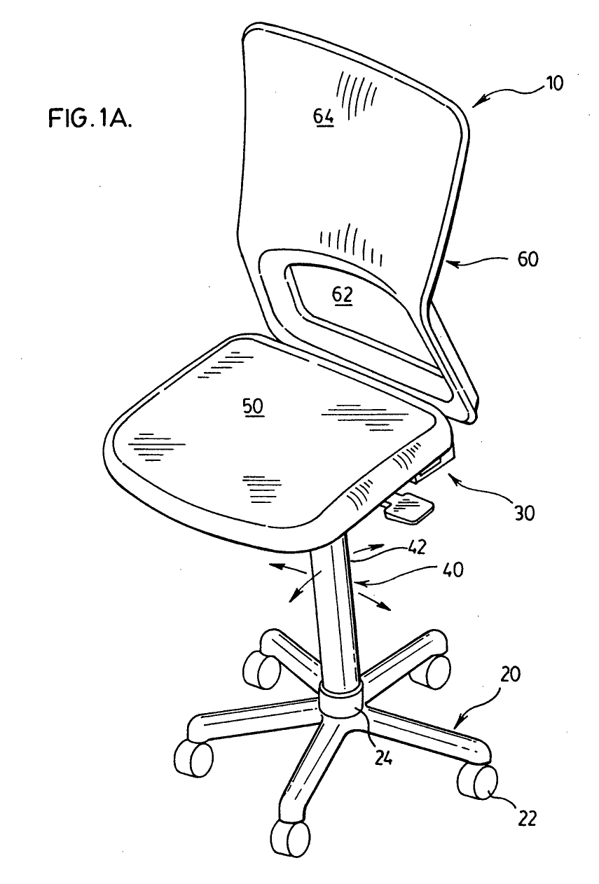

A preferred embodiment of the chair 10 is shown in FIG. 1. The chair 10 is a tilting chair, as shown in FIG. 1A, which tilts proximate to the base 20. The chair 10 is preferably an office chair. The base may include legs and wheels 22 as shown or may be stationary. A variety of base configurations are possible.

A tilt mechanism 24 is located proximate to or within the base 20 which permits the pedestal 42 in the pedestal portion 40 to tilt to circumscribed degrees in all directions. The tilt mechanism may include a resilient element (such as a rubber ring—not shown) which cushions the pedestal 42 as it tilts with respect to the mechanism 24 and returns the pedestal 42 to neutral orientation when tilting force is removed. In addition, the mechanism may include a tilt delimiter (not shown), which may take the form of a keyhole in which the pedestal end is contained to circumscribe the degrees of tilt, especially for preventing excessive tilting in certain directions that may present a tipping or spill hazard.

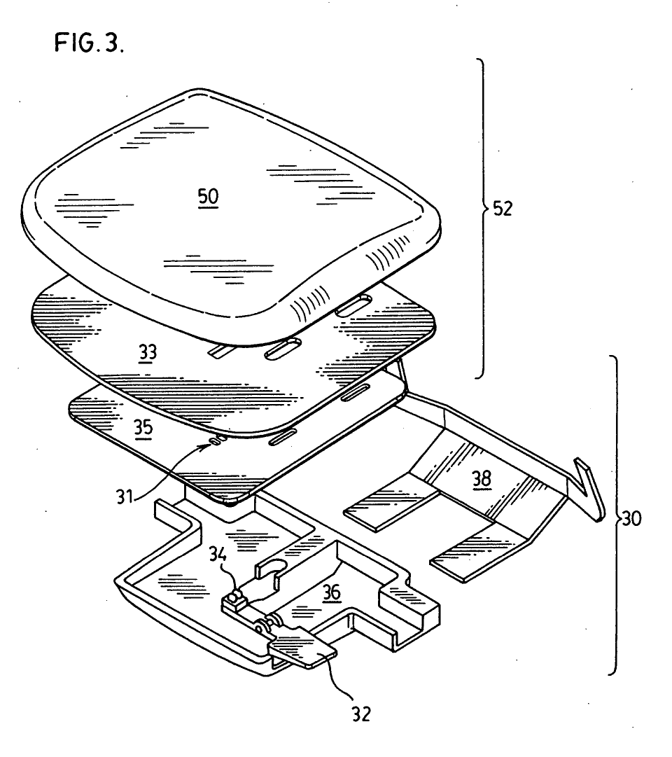

The chair 10 includes a seat pan assembly 52, which preferably has a padded seat pan 50 layer in addition to one or more substrate layers 33, 35, preferably fastened together as a component assembly 52, as shown in an exploded view in FIG. 3. The seat pan assembly 52 is in turn mounted moveably on a chair frame 30. The frame 30 may itself be an assembly, as shown in FIG. 3, including a J-bar component 38 (harnessing the back portion 60 to the undercarriage 36 of the seat).

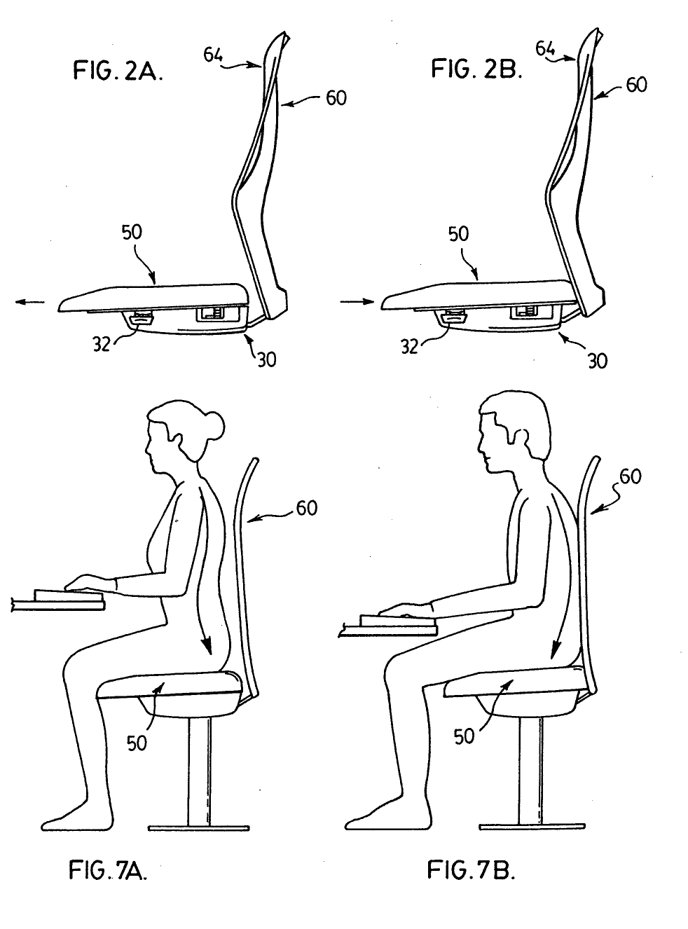

Of note, the frame 30 assembly includes an actuator 32 for moving the seat pan 50 and its substrates 33, 35 in forward and aft directions, as shown in FIGS. 2A and 2B. In a forward position (FIG. 2A), the seat pan assembly 52 is located away from the back portion 60 and back support 64. In an aft position (FIG. 2B), the seat pan assembly 52 is located against the back support 64 of the back support 60.

As shown in FIGS. 7A and 7B, the forward and aft positions are calibrated to be comfortable for women (forward) and men (aft), and markings 80, 82 may be provided on the chair to illustrate which gender is accommodated in each position. The markings may be words, symbols, letters, numbers, color codes, or other indicia. The indicia need not, of themselves, be understood to refer to specific genders. It will be understood that interpretive information illustrating which gender prefers which position may be provided in association with the chair (such as through a brochure, hang tag, website or personal instruction).

Preferably, the actuator has definite position stops for each gender, but a range of intermediate positions may also be provided to accommodate individual seating preferences, and to suit the user's current task (e.g. whether the activity requires a more active forward orientation, or a more reposed aft orientation).

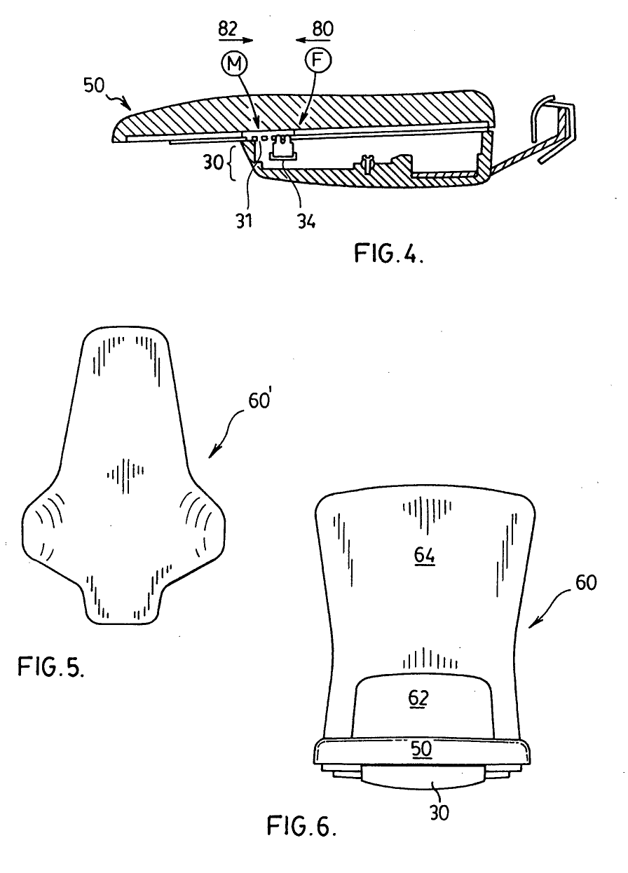

As shown in FIG. 3, the actuator 32 is preferably a lever with a handle accessible to the user. The lever is preferably pivotally attached to the undercarriage 36 part of the frame 30. Opposite the handle on the lever, the actuator preferably has a toothed locking mechanism 34 whose teeth (or pins) engage with corresponding slots or grooves 31 on the underside of the seat pan assembly 52, as shown in FIG. 3. FIG. 4 shows the locking mechanism 34 in engagement with two of a number of slots 31 in the seat pan assembly 52. To move the actuator 32, the user may need to pull (or push) the handle to disengage the teeth from locked position. Then, the user is free to re-direct the seat pan to a desired position where the handle is released and the teeth engage a new set of slots 31 to retain the seat pan assembly in place until the next adjustment. A pair of two teeth on the actuator is preferred for stability and retention, but the actuator may have a single tooth or pin, or some other easily engageable and releasable locking mechanism may be used.

The chair back 60 preferably has a back support 64. Various shapes of back supports 64 are possible. As shown in FIGS. 1, 1A and 6, the back preferably has a lumbar/thoracic “S” curve. Two examples of possible back supports are shown in the Figures. The first 60, shown in FIGS. 1, 1A and 6, is generally (visually) broad across the back with defined upper (thoracic) and lower (lumbar) support sections. Preferably, the back support is flexible in the shoulder area to permit side to side twisting. The second 60′, shown in FIG. 5, is a generally inverted “T” or cruciform shape, which may also have a side-to-side laterally “wing” curvature to cradle and support the user's sides (in the kidney area), this style having an upper portion that is relatively narrow for shoulder flexibility.

In addition to the various back supports 64, a backless or stool-like alternative is possible, in which the front and rear are defined by the movement of the seat pan assembly 52. In such a backless version, the seat pan 50 may be round, rectangular or free-form and preferably curves downwardly from a centre point in the middle of seat pan 50, either in two directions, frontwardly and rearwardly, in the case of a generally rectangular seat pan, or in all directions, in round seat pan.

Either style of back may also include an opening 62 (shown in FIG. 1) for buttock clearance and air circulation.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

1. A tiltable chair accommodating male and female user seating position preferences, comprising:
a base;
a seat frame;
a pedestal portion in between and connecting the base and the seat frame, the pedestal portion being tiltable proximate to the base, so as to tilt the seat frame;
a seat pan mounted on the seat frame and moveable thereon in forward and aft directions;
an adjustor to actuate movement of the seat pan with respect to the seat frame to pre-selected positions in the forward and aft directions,
wherein at least one said position is associated with a female position and at least one said position is associated with a male position.

2. The chair of claim 1, wherein the seat pan can be actuated into at least two predetermined positions.

3. The chair of claim 1, wherein the seat pan can be actuated into exactly two predetermined positions.

4. The chair of claim 1, wherein a forward position of the seat pan with respect to the seat frame corresponds to a male position.

5. The chair of claim 1, wherein an aft position of the seat pan with respect to the seat frame corresponds to a female position.

6. The chair of claim 1, wherein the seat frame comprises a back portion having a back support, the seat pan being moveable in forward and aft directions relative to the back portion.

7. The chair of claim 1, wherein the seat frame is backless, the seat pan being moveable in forward and aft directions relative to the user.

8. The chair of claim 1, wherein the chair comprises an office chair.

9. The chair of claim 1, wherein the base is stationary.

10. The chair of claim 1, wherein the base comprises means for rolling.

11. The chair of claim 1, wherein the base comprises wheels.

12. The chair of claim 1, wherein the pedestal portion comprises a spring assembly for up and down movement driving the seat frame and seat pan in series.

13. The chair of claim 1, wherein the chair comprises a tilt assembly for allowing the chair to slew proximate to the base.

14. The chair of claim 13, wherein the tilt assembly includes a tilt limiter to limit the degree of tilt in selected directions.

15. The chair of claim 1, wherein the seat pan comprises a first side facing the user, and a second side facing the seat frame, wherein the seat pan comprises a plurality of slots defined in the second side, the slots being engageable by a locking mechanism on the actuator to at least temporarily retain the seat pan in a pre-selected position.

16. The chair of claim 15, wherein the actuator comprises a lever pivotally attached to the seat frame, the lever having a proximate end manually accessible to the user, and an opposite distal end, the locking mechanism being attached to the distal end for engagement in at least one of the slots on the seat pan.

17. The chair of claim 16, wherein the locking mechanism comprises at least one projecting tooth attached to the lever for engagement in at least one of the slots on the seat pan.

18. The chair of claim 17, wherein the locking mechanism comprises two projecting teeth.

19. The chair of claim 1, wherein the female position and the male position are marked on the seat frame.

20. The chair of claim 1, wherein the female position and the male position are marked on the seat pan.

21. The chair of claim 1, wherein the female position and the male position are marked on the actuator.

22. The chair of claim 1, wherein the chair has accompanying literature on female and male positions.

23. The chair of claim 6, wherein the back support comprises an inverted T-shaped back support, which is relatively narrower between the user's shoulder blades and relatively wider proximate to the user's lower back.

24. The chair of claim 6, wherein the back support comprises an upper back support portion and a lower back support portion, an opening being defined in the lower back support portion, the opening being adapted to allow the user's buttocks to protrude therethrough when the user is positioned against the back support as the seat pan is moved in the aft direction.
